(19) United States
(12) Patent Application Publication
(10) Pub. No.: US 2023/0215001 A1
(43) Pub. Date: Jul. 6, 2023

(54) METHOD FOR FACILITATING CARIES DETECTION

(71) Applicant: CHUNG SHAN MEDICAL UNIVERSITY, Taichung City (TW)

(72) Inventors: Chia-Tze KAO, Taichung City (TW); Chih-Jen TSENG, Taichung City (TW)

(73) Assignee: CHUNG SHAN MEDICAL UNIVERSITY, Taichung City (TW)

(21) Appl. No.: 18/082,917

(22) Filed: Dec. 16, 2022

(30) Foreign Application Priority Data
Jan. 5, 2022 (TW) 111100413

(51) Int. Cl. G06T 7/00

(52) U.S. Cl. CPC G06T 7/0012; G06T 2207/30036

(57) ABSTRACT

A method for facilitating caries detection is to be performed based on a grayscale image of teeth, and includes: obtaining an object detection model; obtaining a detection image using the object detection model based on the grayscale image, wherein the detection image is the grayscale image labeled with a plurality of tooth crown marks and a caries mark; and for one of the tooth crown marks that has the caries mark provided thereon, determining a width and a height of the tooth crown mark and a width and a height of the caries mark, and calculating a caries ratio based on the aforementioned widths and heights to obtain an evaluation result that indicates a severity of caries.

### CROSS-REFERENCE TO RELATED APPLICATION

This application claims priority to Taiwanese Invention Patent Application No. 111100413, filed on Jan. 5, 2022.

### FIELD

The disclosure relates to a method for facilitating caries detection, and more particularly to a method for facilitating caries detection using machine learning.

### BACKGROUND

Conventionally, in determining whether a patient has dental caries, a dentist may use a mouth mirror to inspect appearances of the teeth, use a dental explorer to gently press surfaces of the teeth for tactile inspection and inquire if any pain is felt, or use dental radiography (X-ray) to obtain a panoramic X-ray image of the teeth for aiding in the diagnosis. These approaches heavily rely on the patient's personal feelings and the dentist's experience. If the patient cannot properly express his/her feelings or the dentist has not built up sufficient experience, dental caries might not be detected, which would result in delayed treatment.

### SUMMARY

Therefore, an object of the disclosure is to provide a method for facilitating caries detection that can aid a dentist in accurately and objectively evaluating dental conditions, and that can alleviate at least one of the drawbacks of the prior art.

According to the disclosure, the method for facilitating caries detection is to be performed based on a grayscale image that includes a plurality of tooth crown areas that respectively correspond to tooth crowns of teeth of a patient. The method includes a step of obtaining an object detection model, a step of obtaining a detection image based on the grayscale image using the object detection model, wherein the detection image is the grayscale image labeled with a plurality of tooth crown marks that respectively indicate the tooth crown areas and a caries mark that indicates a caries area which corresponds to a portion of one of the teeth that has caries and which extends from a contour toward an inner portion of one of the tooth crown areas, a step of determining, for one of the tooth crown marks that has the caries mark provided thereon, a width and a height of the tooth crown mark and a width and a height of the caries mark in the detection image, and a step of, for said one of the tooth crown marks that has the caries mark provided thereon, calculating a sum of the width and the height of the caries mark to obtain a total caries value, calculating a sum of the width and the height of the tooth crown mark to obtain a total crown value, and calculating a caries ratio as a ratio of the total caries value to the total crown value to obtain an evaluation result that indicates a severity of caries.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating an embodiment of a method for facilitating caries detection according to the disclosure.

FIG. 2 is a schematic diagram illustrating an embodiment of a grayscale image according to the disclosure.

FIG. 3 is a schematic diagram illustrating an embodiment of a marked image according to the disclosure.

FIG. 4 is a schematic diagram illustrating an embodiment of a detection image that includes tooth crown marks according to the disclosure.

FIG. 5 is a schematic diagram illustrating an embodiment of the detection image that further includes a caries mark according to the disclosure.

FIG. 6 is a schematic diagram illustrating an embodiment of a part of the detection image according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

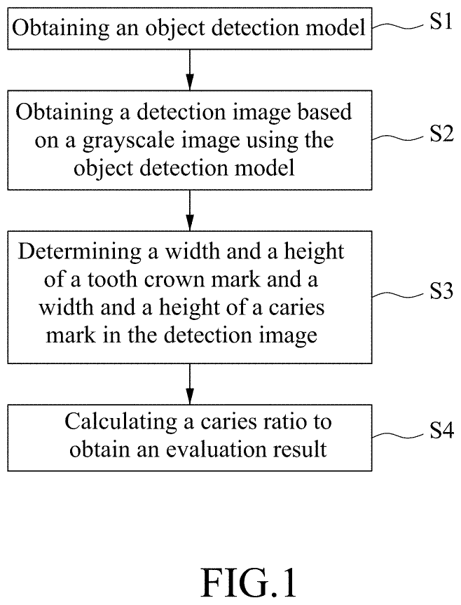

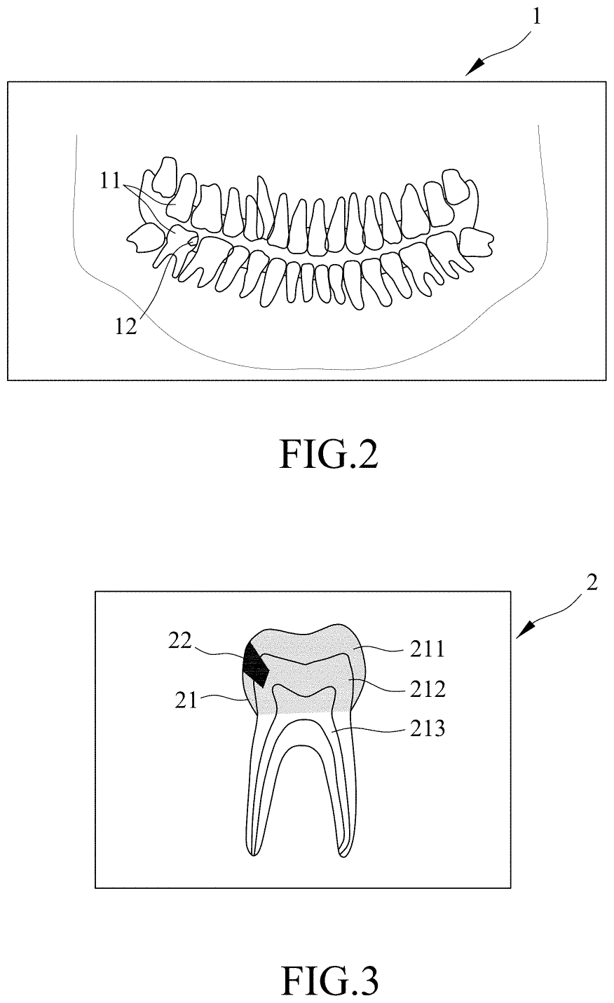

Referring to FIGS. 1 and 2, a method for facilitating caries detection according to an embodiment of the disclosure is illustrated. The method is adapted for assisting a user to determine whether a patient has caries inside the oral cavity, and is implemented through analyzing a grayscale image 1 related to the patient using machine learning. It is noted that the grayscale image 1 exemplarily shown in FIG. 2 is provided for explanatory purposes and details of grayscales therein are not illustrated. However, in practice, the grayscale image 1 may be shown in many shades of gray. In some embodiments, the grayscale image 1 is, for example but not limited to, a panoramic X-ray image of the teeth of the patient that is obtained through dental radiography which has high accessibility and ease of use.

The grayscale image 1 has a plurality of tooth crown areas 11, and at least one caries area 12 that extends from a contour toward an inner portion of at least one tooth crown area among the tooth crown areas 11. It is noted that the tooth crown areas 11 respectively correspond to tooth crowns of the teeth of the patient, where tooth crowns refer to portions of the teeth covered by enamel and are usually visible inside the oral cavity. The caries area 12 corresponds to a portion of a tooth that has caries, i.e., tooth decay, caused by acid from bacteria dissolving hard tissues of the tooth. It is noted that a patient having dental caries is taken as an example in this disclosure so that the grayscale image 1 has the caries area 12, but in other embodiments, the grayscale image 1 may not have the caries area 12. Moreover, for the purpose of clear explanation of the method in this disclosure, the grayscale image 1 shown in FIG. 2 has multiple tooth crown areas 11 and only one caries area 12. However, in other embodiments, the grayscale image 1 may have multiple tooth crown areas 11 and multiple caries areas 12, depending an oral health condition of the patient.

In some embodiments, the method for facilitating caries detection is to be performed by an electronic device (not shown) that includes a memory and a processor. The memory may store a plurality of instructions that when read by the processor cause the processor to execute steps of the method according to the disclosure. In some embodiments, the electronic device is implemented by a server (e.g., an application server or a computing server), a personal computer, a notebook computer, a tablet computer, a smartphone, or the like; the memory is implemented by flash memory, a hard disk drive (HDD), a solid state disk (SSD), an electrically-erasable programmable read-only memory (EEPROM) or any other non-volatile memory devices; the processor is implemented by a central processing unit (CPU), a microprocessor, a mobile processor, a micro control unit (MCU), a digital signal processor (DSP), a field-programmable gate array (FPGA), or any circuit configurable/programmable in a software manner and/or hardware manner to implement functionalities described in this disclosure.

Referring to FIG. 1, the method for facilitating caries detection begins at step S1, where the electronic device obtains an object detection model, and stores the object detection model in the memory. In some embodiments, the object detection model is generated by performing a training process on a machine learning algorithm, such as an artificial neural network. In some embodiments, TensorFlow using Python programming language is adopted as the deep learning framework and a plurality of training data sets are used to carry out the training process. It is noted that the training process used to generate the object detection model may be performed by the electronic device, or may alternatively be performed by another training device, and then the training device may provide the object detection model to the electronic device. In some embodiments, the object detection model may be a mask R-CNN (region convolution neural network) model. In some embodiments, test data sets may be used to provide an evaluation on the object detection model.

Referring to FIG. 3, an example of one of the training data sets is illustrated, wherein the training data set contains a marked image 2 that is a training grayscale image (e.g., an X-ray image) of teeth (only one tooth is shown) labeled with a training crown mark 21, a training caries mark 22, a training enamel mark 211, a training dentin mark 212 and a training pulp mark 213. Similar to FIG. 2, details of grayscales of the marked image 2 are not illustrated in FIG. 3. It is noted that the aforementioned marks may be manually labeled on the training grayscale image by dental professionals to result in the marked image 2. The training crown mark 21 is shown in gray and indicates a tooth crown area that corresponds to a tooth crown of the tooth; the training caries mark 22 is shown in black and indicates a caries area that corresponds to a portion of the tooth that has caries; the training enamel mark 211 indicates the enamel of the tooth; the training dentin mark 212 indicates the dentin of the tooth; and the training pulp mark 213 indicates the pulp of the tooth. Since the enamel, the dentin and the pulp have different textures, these hard tissues are presented by three different grayscale value ranges in the marked image 2, and can thus be recognized and marked by the dental professionals. In some embodiments, since the density of the enamel is higher than that of the dentin and the density of the dentin is higher than that of the pulp, the enamel appears lighter in grayscale than the dentin, and the pulp appears darker in grayscale than the dentin. In this way, the dentin is presented by a grayscale value range that is lower than that of the enamel, and the pulp is presented by a grayscale value range that is lower than that of the dentin. For example, the enamel is presented by a grayscale value range greater than 200, the dentin is presented by a grayscale value range from 150 to 200, and the pulp is presented by a grayscale value range smaller than 150. It is noted that for the purpose of clear explanation, only a part of the marked image 2 is illustrated in FIG. 3 to show one tooth, but in practice, the marked image 2 is similar to the grayscale image 1 exemplarily shown in FIG. 2 and includes a panoramic X-ray image and is further labeled with the aforementioned marks.

In some embodiments, the training grayscale images of the training data sets undergo several image processing steps (i.e., data preprocessing) in advance to being used in the training process, and more than a hundred of the training data sets are used to generate the objection detection model. The image processing steps include, for example but not limited to, data conversion, data sorting, grayscale conversion, image positioning and tooth detection. Regarding data conversion, panoramic X-ray images are usually stored in the file format of Digital Imaging and Communications in Medicine (DICOM), and are converted to another file format more suitable for image processing, such as Joint Photographic Experts Group (JPEG). Regarding data sorting, panoramic X-ray images that are unsuitable for model training, such as panoramic X-ray images of teeth having the issue of teeth overlapping, are removed. Regarding grayscale conversion, since panoramic X-ray images produced by different dental radiography devices may have different grayscale ranges (e.g., −3000 to 3000), the grayscale ranges are thus converted to a common standard (e.g., 0 to 255) for subsequent processing. Regarding image positioning, computers are utilized to adjust the panoramic X-ray images such that objects (e.g., teeth) in each of the panoramic X-ray images may be framed and moved to a common position (e.g., the center) in the respective image. Regarding tooth detection, for each of the panoramic X-ray images, based on differences of grayscale values near edges of the teeth, each individual tooth may be detected by a preset algorithm.

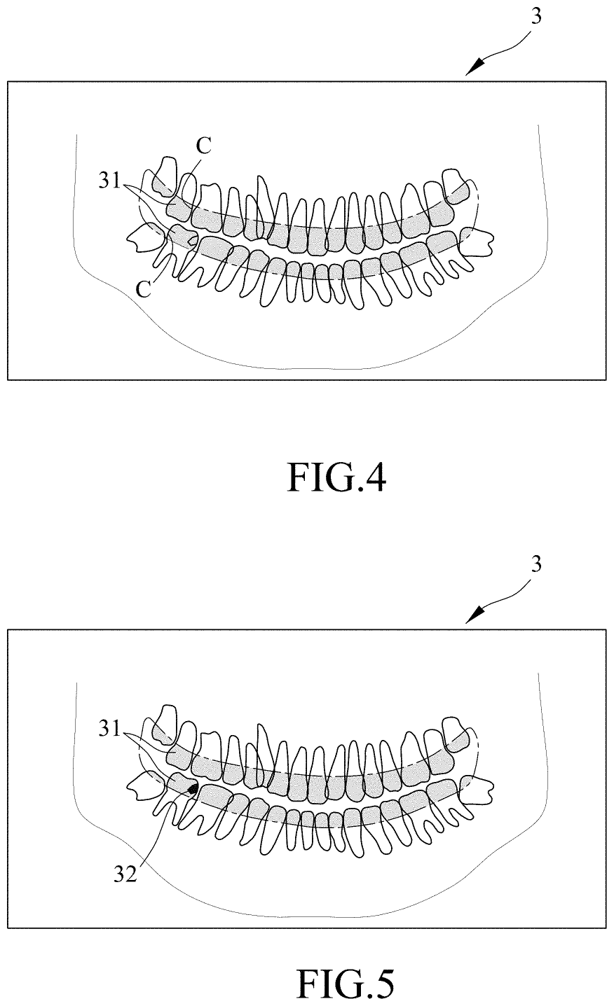

Referring to FIG. 1, in step S2 of the method according to this disclosure, the electronic device obtains a detection image 3 using the object detection model based on the grayscale image 1. Referring to FIG. 4, the detection image 3 is the grayscale image 1 labeled with a plurality of tooth crown marks 31 that respectively indicate the tooth crown areas 11 (see FIG. 1), and referring to FIG. 5, the grayscale image 1 is further labeled with a caries mark 32 that indicates the caries area 12 which extends from a contour toward an inner portion of a corresponding one of the tooth crown areas 11. It is noted that in the example given herein, since there is only one caries area 12 in the grayscale image 1, only one caries mark 32 is labeled. However, when the grayscale image has multiple caries areas 12, multiple caries marks 32 will be labeled in step S2. Specifically, the processor of the electronic device provides the grayscale image 1 as input data to the object detection model stored in the memory and executed by the processor, and the object detection model then generates the detection image 3 that includes the grayscale image 1 labeled with the tooth crown marks 31 and the caries mark(s) 32 as output data. In FIGS. 4 and 5, a dot-dashed line illustrates edges of the alveolar bone of the patient, the tooth crown marks 31 are shown in gray, and the caries mark 32 is shown in back. In some embodiments, the object detection model outputs the detection image 3 by detecting objects (e.g., the tooth crown areas 11 and the caries area 12) based on grayscale values of features in the grayscale image 1, and labeling the objects thus detected with the aforementioned marks.

Specifically, the processor of the electronic device uses the object detection model to determine a plurality of U-shaped curves C that have grayscale values greater than 200 in the grayscale image 1 as parts of edges of the tooth crown areas 11, and to label the grayscale image 1 with the tooth crown marks 31 indicating the tooth crown areas 11. Since the enamel is the hardest tissue in the human body, is highly mineralized and has a high density, the enamel appears lightest in grayscale in the grayscale image 1 and thus has the highest grayscale value. Therefore, the processor uses the object detection model to detect U-shaped curves that have grayscale values greater than 200 as edges of the enamel so as to define the tooth crown areas 11.

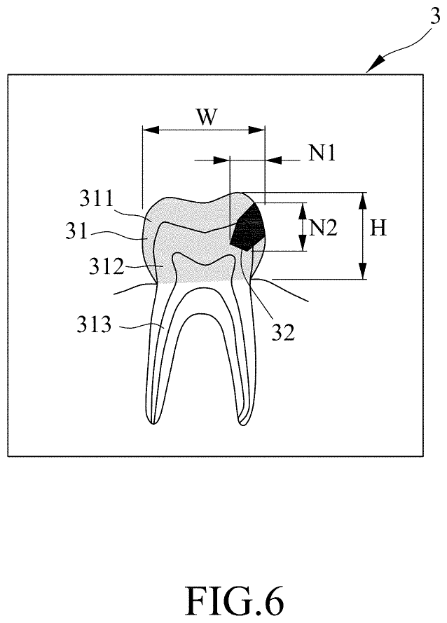

Referring to FIGS. 1 and 6, in step S3 of the method according to this disclosure, the electronic device, for each tooth crown mark 31 that has a caries mark 32 provided thereon, determines a width W and a height H of the tooth crown mark 31 and a width N1 and a height N2 of the caries mark 32 in the detection image 3. It is noted that, only a part of the detection image 3 is illustrated in FIG. 6 to exemplarily show a tooth having caries (i.e., the tooth labeled with both the tooth crown mark 31 and the caries mark 32). In some embodiments, the width W of the tooth crown mark 31 and the width N1 of the caries mark 32 are defined in a direction parallel to an X-axis of the detection image 3, and the width N1 is the largest width of the caries in the tooth crown area 11 in a lateral direction of the tooth. Similarly, the height H of the tooth crown mark 31 and the height N2 of the caries mark 32 are defined in a direction parallel to a Y-axis of the detection image 3, and the height N2 is the largest depth of the caries in the tooth crown area 11 in a longitudinal direction from the occlusal surface to the root of the tooth.

Referring to FIGS. 1 and 6, in step S4 of the method according to this disclosure, the electronic device, for each tooth crown mark 31 that has a caries mark 32 provided thereon, calculates a sum of the width N1 and the height N2 of the caries mark 32 to obtain a total caries value, calculates a sum of the width W and the height H of the tooth crown mark 31 to obtain a total crown value, and calculates a ratio of the total caries value to the total crown value (also referred to as “caries ratio” hereinafter) to obtain an evaluation result that indicates a severity of caries associated with the corresponding tooth of the patient. It is noted that since a tooth has a layered structure, and caries usually occurs from an exterior to an interior of the tooth and develops in lateral and longitudinal directions, by adding up the width N1 and the height N2 of the caries mark 32 and by adding up the width W and the height H of the tooth crown mark 31, an overall state of the caries with respect to the tooth may be evaluated.

In some embodiments, the caries ratio (i.e., the evaluation result) is calculated based on a function of:

$$caries ratio = \frac{width N 1 + height N 2}{width W + height H} \times 100 \% .$$

In clinical treatment, a dentist adopts different approaches to treat dental caries depending on a depth and/or a width of the caries in the tooth crown. Since the tooth crown area 11 and the caries area 12 have irregular shapes for different teeth and are also different among different individuals, it is relatively difficult to evaluate a severity of caries based on a ratio of an area of the caries area 12 and an area of the tooth crown area 11. Therefore, in this disclosure, the largest width and the largest depth of the caries area 12 in the tooth crown area 11 are determined, the total caries value is then calculated, and the caries ratio of the total caries value to the total crown value is calculated next so as to determine a proportion of the tooth crown area 11 taken up by the dental caries. In this way, the severity of caries related to the caries area 12 with respect to the tooth crown area 11 can be evaluated. Through numerical presentation, a standardized classification can be established, and is exemplarily shown in a table below.

| Caries ratio (evaluation result) | Classification |
|---|---|
| <20% | Mild caries |
| 20% to 40% | Moderate caries |
| 40% to 80% | Severe caries |
| >80% | Very severe caries |

In some embodiments, when the caries ratio is smaller than 20%, it means that the caries area 12 extends from a surface toward the interior of the tooth crown area 11 but does not reach a midpoint of the enamel in terms of depth. In other words, the tooth crown corresponding to the tooth crown area 11 has mild caries. When the caries ratio ranges from 20% to 40%, it means that the caries area 12 extends from the surface toward the interior of the tooth crown area 11 and reaches the midpoint of the enamel in terms of depth. In other words, the tooth crown corresponding to the tooth crown area 11 has moderate caries. When the caries ratio ranges from 40% to 80%, it means that the caries area 12 extends from the surface toward the interior of the tooth crown area 11, reaches a junction of the enamel and the dentin, but does not reach a midpoint of the dentin in terms of depth. In other words, the tooth crown corresponding to the tooth crown area 11 has severe caries. When the caries ratio is greater 80%, it means that the caries area 12 extends from the surface toward the interior of the tooth crown area 11 and reaches the midpoint of the dentin in terms of depth. In other words, the tooth crown corresponding to the tooth crown area 11 has very severe caries.

By using the electronic device that stores the object detection model to obtain the evaluation result, a dentist is capable of objectively determining a degree of severity of dental caries related to the caries area 12 with respect to the tooth crown area 11 based on the evaluation result. Particularly for a case of mild caries, since the degree of severity of dental caries is relatively low and the patient might not feel any pain, when the dentist inspects the grayscale image 1 (i.e., a panoramic X-ray image) of the patient with his/her own eyes and consults the patient, the dentist might overlook the mild caries. Therefore, the method for facilitating caries detection according to this disclosure is capable aiding a dentist in quickly determining dental caries by providing numerical information, and in evaluating a severity of the caries in an objective manner. In this way, dental caries can be detected in an early stage and treated earlier, so that the risk of delayed treatment can be prevented, the pain of the patient can be reduced, and the treatment effect can be promoted.

Referring to FIGS. 1 and 6, in some embodiments, in step S2 of the method according to the disclosure, in addition to the tooth crown marks 31 and the caries mark(s) 32, the grayscale image 1 is further labeled, with respect to each tooth in the oral cavity, with an enamel mark 311 that indicates the enamel, a dentin mark 312 that indicates the dentin and a pulp mark 313 that indicates the pulp. In other words, in response to receipt of the grayscale image 1 as the input data, the object detection model generates the detection image 3 as the output data by labeling the grayscale image 1 with the tooth crown marks 31, the caries mark(s) 32, the enamel marks 311 (only one is shown), the dentin marks 312 (only one is shown) and the pulp marks 313 (only one is shown). In this way, the dentist may be aided to determine which layer(s) of tissue the caries has reached in the corresponding tooth. For example, referring to FIG. 6, the caries mark 32 extends from a contour of the enamel mark 311 to reach a center of a layer labeled by the dentin mark 312. Based on this, the dentist can easily make a judgment that the caries has developed to reach the dentin of the tooth and adopt appropriate treatment to treat the tooth.

To sum up, by labeling the grayscale image 1 with the aforementioned marks in step S2 using the object detection model, by determining dimensions of a caries mark 32 and the corresponding tooth crown mark 31 in step S3, and by calculating the caries ratio in step S4, the method for facilitating caries detection according to this disclosure is capable of evaluating a degree of severity of dental caries. Based on the numerical information (i.e., the caries ratio), a dentist may be aided in evaluating a degree of severity of dental caries in a fast, accurate and objective manner. In this way, the likelihood that subjective feelings of the patient and lack of clinical experience of the dentist might adversely affect the result of diagnosis may be reduced. The risk of delayed treatment may also be prevented.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for facilitating caries detection to be performed based on a grayscale image that includes a plurality of tooth crown areas that respectively correspond to tooth crowns of teeth of a patient, the method comprising:
obtaining an object detection model;
obtaining a detection image based on the grayscale image using the object detection model, wherein the detection image is the grayscale image labeled with a plurality of tooth crown marks that respectively indicate the tooth crown areas and a caries mark that indicates a caries area which corresponds to a portion of one of the teeth that has caries and which extends from a contour toward an inner portion of one of the tooth crown areas;
determining, for one of the tooth crown marks that has the caries mark provided thereon, a width and a height of the tooth crown mark and a width and a height of the caries mark in the detection image; and
for said one of the tooth crown marks that has the caries mark provided thereon, calculating a sum of the width and the height of the caries mark to obtain a total caries value, calculating a sum of the width and the height of the tooth crown mark to obtain a total crown value, and calculating a caries ratio as a ratio of the total caries value to the total crown value to obtain an evaluation result that indicates a severity of caries.

2. The method as claimed in claim 1, wherein obtaining a detection image includes:
providing the grayscale image as input data to the object detection model so that the object detection model generates the detection image that includes the grayscale image labeled with the tooth crown marks and the caries mark as output data.

3. The method as claimed in claim 1, wherein obtaining a detection image includes:
using the object detection model to determine a plurality of U-shaped curves that have grayscale values greater than 200 in the grayscale image as parts of edges of the tooth crown areas, and to label the grayscale image with the tooth crown marks indicating the tooth crown areas.

4. The method as claimed in claim 1, wherein obtaining an object detection model includes:
generating the object detection model by performing a training process on a machine learning algorithm, wherein in the training process, TensorFlow using Python programming language is adopted as the deep learning framework.

5. The method as claimed in claim 4, wherein a plurality of training data sets are used to carry out the training process, each of the training data sets containing a marked image that is a training grayscale image of a tooth labeled with a training crown mark and a training caries mark, the training crown mark indicating a tooth crown area that corresponds to a tooth crown of the tooth, the training caries mark indicating a caries area that corresponds to a portion of the tooth that has caries.

6. The method as claimed in claim 5, wherein for each of the training data sets, the training grayscale image is further labeled with a training enamel mark that indicates enamel of the tooth, a training dentin mark that indicates dentin of the tooth and a training pulp mark that indicates pulp of the tooth to result in the marked image, the dentin being presented by a grayscale value range lower than that of the enamel in the training grayscale image, and the pulp being presented by a grayscale value range lower than that of the dentin in the training grayscale image.

7. The method as claimed in claim 6, wherein for each of the training data sets, the grayscale value range used to present the enamel is greater than 200, and the grayscale value range used to present the dentin is from 150 to 200.

8. The method as claimed in claim 1, wherein in obtaining a detection image, the grayscale image is further labeled by the object detection model, with respect to each of the teeth of the patient, with an enamel mark that indicates enamel, a dentin mark that indicates dentin and a pulp mark that indicates pulp.

9. The method as claimed in claim 1, wherein for said one of the tooth crown marks that has the caries mark provided thereon, the caries ratio is calculated based on a function of:
$$caries ratio = \frac{width N 1 + height N 2}{width W + height H} \times 100 \% ,$$
where N1 and N2 respectively represent a width and a height of the caries mark, and W and H respectively represent a width and a height of the tooth crown mark in the detection image.

10. The method as claimed in claim 9, wherein for said one of the tooth crown marks that has the caries mark provided thereon, when the caries ratio thus calculated is smaller than 20%, the severity of caries is indicated to be mild; when the caries ratio thus calculated ranges from 20% to 40%, the severity of caries is indicated to be moderate; when the caries ratio thus calculated ranges from 40% to 80%, the severity of caries is indicated to be severe; and when the caries ratio thus calculated is greater than 80%, the severity of caries is indicated to be very severe.
